(19) United States
(12) Patent Application Publication
(10) Pub. No.: US 2007/0011322 A1
(43) Pub. Date: Jan. 11, 2007

(54) Method and system for providing access to web services

(76) Inventor: Corrado Moiso, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/573,828

(22) PCT Filed: Sep. 30, 2003
(86) PCT No.: PCT/IT03/00585

§ 371 Date: Mar. 29, 2006

(51) Int. Cl. G06F 15/173

(52) U.S. Cl. 709/225

(57) ABSTRACT

Software applications are provided access to web services, such as Parlay X web services, by providing a Parlay gateway permitting access to web services and including a Parlay framework. A set of modules having service interfaces for the software applications is provided, the modules in the set acting as proxies in order to perform requests for access to web services on the framework of the Parlay gateway on behalf of the software applications.

### FIELD OF THE INVENTION

The present invention generally relates to techniques for providing access to web services.

The invention was developed by paying specific attention to the possible use in accessing telecommunication network capabilities and providing software applications access to Parlay X web services.

Reference to these possible, specific applications is in no way to be construed as limiting the scope of the invention: in fact, the invention is applicable in introducing a secure and controlled access to any generic web service.

### DESCRIPTION OF THE RELATED ART

In recent times, a growing interest is being demonstrated for those services that mix information technology applications (e.g. corporate information systems, internet/web applications) with the capabilities provided by a telecommunication network, such as capabilities for setting-up and controlling calls, getting the location of mobile equipment, sending and receiving SMSs or MMSs.

Such applications can be developed and deployed by actors different from traditional network operators, such as corporate entities or providers of services over the “big” Internet. Examples of such applications are network call centers, fleet management applications or “click-to-dial” applications. In this case the network operator will need to provide access to its network capabilities for applications deployed in a domain different from the domain of the network operator.

Parlay is a solution that allows software applications to access capabilities implemented in telecommunication networks, including control of phone calls, interaction with users through different carriers (e.g. voice, SMS, USSD), localization of terminals, status/presence information of end-users, control of data sessions, terminal capability access, and account management and content-based charging.

In the following, the present invention is referred in the description and in the claims to Parlay standard as specified in ETSI and 3GPP documents. However it is clear, as an expert on the field can appreciate, that the present invention is applicable or directed either to any possible extension of the Parlay standard or to similar solutions using Parlay equivalent functions and interfaces.

General information on Parlay can be found in the following documents:

[Parlay] Open Service Access (OSA), ETSI ES 202 915-1 V1.1.1 (2003-01)

This is the latest Parlay specification (published by ETSI), which describes the Parlay APIs for framework and service interfaces.

[ParlayXWP] Parlay X Working Group, White Paper, 16 Dec. 2002

This document describes the introduction of Parlay X web services and their possible relationship with a Parlay gateway.

[ParlayX] Parlay X Working Group, Parlay X Web Services Specification v1.0, 9 May 2003

This is the latest specification of Parlay X web services.

[ParlayWSComparison] Parlay Web Services Working Group, Parlay Web Services Architecture Comparison, 31 Oct. 2002

This document compares the Parlay and web service architectural models, by pointing out the difference between the Parlay framework and the repository of web services implemented by as a UDDI server.

[ParlayWSDeployment] Parlay Web Services Working Group, Parlay Web Services Application Deployment Infrastructure, 31 Oct. 2002

This document presents some possible deployment scenarios of Parlay X web services, without however describing their realization in general, and the structure of the Parlay X web services in particular.

In Parlay (FIG. 1), interaction among software applications A1, A2, . . . , An and network capabilities NC is achieved through a set of service interfaces, provided as application programming interfaces API by means of a distributed processing mechanism DPM such as e.g. the Common Object Request Broker Architecture (CORBA) overseen by the non-profit organization named OMG (Object Management Group).

As the software applications can be deployed and operated in an administrative domain different from the network operator domain, Parlay implements some functions, named “framework” functions FI+FF that enable a secure and controlled access to the service interfaces SI.

The Parlay application programming interfaces API are implemented by a Parlay gateway PG, which may comprise a distributed set of servers, each of which implements the framework functions and/or the module to implement the service interfaces SCS (named Service Capability Servers—SCSs) by interacting with the network capabilities NC.

The Parlay gateway includes a framework module FI+FF, that performs the following functions:
authentication of the applications;
authorization for the applications to access the network capabilities;
registration of new service interfaces to be accessed through the gateway;
management of the profiles containing the data characterizing the subscription of an application to a Service Interface (e.g. configuration data, limitations on the use, etc.);
binding of an application to a service interface (or, better the module implementing the access to a service interface), instantiated according to the corresponding subscription profile data;
integrity management to verify the correct behavior of all the components of the system (e.g. applications, modules implementing the Service Interfaces).

The Parlay solution and APIs are published by ETSI, were adopted by the 3GPP and form the so-called Open Service Access (OSA) standard.

As Parlay APIs are quite complex to use, several attempts to provide simplifications were proposed.

One of these is Parlay X. Essentially, Parlay X is a set of APIs (FIG. 2, Parlay X Web Services), defined according to the web service mechanism (i.e. they are defined by using the XML-based language WSDL, and are invoked with SOAP protocol (Simple Object Access Protocol) as distributed processing protocol) that provide a greater level of abstraction to network capability control and more oriented to web application developers. According to the Parlay X reference model, Parlay X web services could be implemented by Parlay X Servers PXS that interact with a Parlay gateway PG or with the network resources NE.

Specifically, in FIG. 1, A1, A2, . . . , An are applications that access via a distributed processing mechanism DPM (such as CORBA) a Parlay/OSA gateway PG. This includes service interfaces SI and respective associated software modules SCS that implement the behavior of the Parlay web services. The gateway PG also includes framework interfaces FI and framework functions FF. The network capabilities are generally designated NC.

In the Parlay X reference model of FIG. 2, the designation PA denotes Parlay applications (in Java, C and so on), while the designation PXA denotes Parlay X applications (in Java, C, XML Script and so on). The Parlay gateway, that interfaces with the applications PA via Parlay APIs is again designated PG. Access of the Parlay X applications PXA to the gateway PG and network elements NE is via Parlay X servers PXS.

A point still open in the Parlay X solution is how Parlay X web services can be accessed in a secure and controlled way by software application PXA deployed in third party administrative domains.

Certain possible solutions addressing this open point are described in the document concerning ParlayWSDeployment cited in the foregoing. That document describes some possible deployment architectures for Parlay X web services (without however describing their realization), and specifically proposes to interact with Parlay framework functions before accessing of Parlay X web service. As a basic drawback, this arrangement requires an explicit interaction of an application that wants to use the Parlay X web services with the Parlay framework interfaces: such an interaction is not appropriate for applications based on the web service model.

In fact, the interfaces provided by the Parlay framework impose an interaction model which is not aligned with the web service interaction model adopted for example by Parlay X web services: the Parlay framework interface interactions are based on complex transactions of message exchanges, which are quite different from the simple “request-response” interaction model of web services. Moreover, before obtaining access to a web service interface, applications based on web services do not have to perform a set of authentication and authorization operations, such as those required by the interaction of the Parlay framework.

A more detailed comparison among Parlay and the web service model is reported in the document ParlayWSComparison already mentioned in the foregoing.

Moreover, the document ParlayWSDeployment proposes to use protocols conceived for “generic” web service secure invocations (e.g. WS-Security) in order to invoke Parlay X web services as well. These protocols would be used to transport the information needed for the authentication and authorization steps. Such a document suggests, in particular, to add new servers, external to the Parlay architecture, to perform the authentication and the authorization steps of Parlay X Web services.

The document referred to in the foregoing as [ParlayX] includes a caption to WO-A-02/11459.

In WO-A-02/11459 the problem is tackled of introducing a level of abstraction on the application side (named PCP) in order to access Parlay gateway APIs. To that end, the applications are co-located in the same system or, at least, in the same administrative domain with the software modules that implement the abstraction layer. The arrangement of WO-A-02/11459 does not cover the issues related to the use of web service technologies or, in particular, Parlay X Web Services.

### OBJECT AND SUMMARY OF THE INVENTION

In view of the prior art considered in the foregoing, the need is felt for arrangements adapted to implement a secure, controlled and configured access to web services such as Parlay X web services by software applications deployed in third party domains.

More specifically, the need is felt for an arrangement that:
does not require additional servers external to the Parlay architecture, thus making it possible to exploit the servers already deployed in a Parlay solution, i.e. the Parlay framework functions and the administrative systems used for configuring the authentication, authorization and configuration data associated to an application that wishes to use a web service such as a Parlay X web service, and
is well integrated with the web service computational model: in fact the Parlay X Applications, for example, are not required to interact with additional servers in order to perform the authentication and the authorization steps.

The object of the present invention is thus to provide an improved arrangement fulfilling those needs.

According to the present invention, that object is achieved by means of a method having the features set forth in the claims that follows. The invention also relates to a corresponding system, a related communication network as well as a related computer program product loadable in the memory of at least one computer and including software code portions for performing the steps of the method of the invention when the product is run on at least one computer. Reference to at least one computer is evidently intended to take into account the fact that the invention is adapted to be implemented in a distributed processing arrangement.

A preferred embodiment of the arrangement described herein is a method for providing software applications access to web services, by:
providing a Parlay gateway (PG) permitting access to web services, the Parlay gateway (PG) including a Parlay framework (FW), and
providing a set of modules (PX WS) comprising service interfaces for the software applications, the modules (PX WS) in question acting as proxies in order to perform requests for access to web services on the framework (FW) of the Parlay gateway on behalf of the software applications.

In general, as known, a proxy function is a module or combination of modules which perform actions on behalf of a requester (i.e. the software application) in order to grant the access to external services (i.e. web services); for example a proxy function can comprise authentication, authorization, execution requests on the Parlay gateway functions/modules on behalf of the Parlay X applications.

A preferred embodiment of the arrangement described herein offers the following advantages:
a web service such as a Parlay X web service can perform the authentication of software applications that wish to access it by exploiting the authentication mechanism provided by the framework functions in a Parlay gateway;
a web service such as a Parlay X web service can verify whether a software application that wishes to access it is authorized or not by exploiting the authorization mechanism provided by the framework functions in a Parlay gateway;
the behavior of a web service such as a Parlay X web service can be customized, by exploiting the service property mechanisms provided by the framework functions in a Parlay gateway.

From the application viewpoint, the arrangement described herein guarantees that applications can access Parlay X web services and any other web services that adopt WS-Security invocation protocol (or alternative web service secure invocation protocols), without explicit interaction with additional servers in order to perform the authentication and the authorization steps.

It will be appreciated that the arrangement described herein is not per se related to how the web service methods can map on the Parlay service interfaces in order to implement the control and monitoring of specific network capabilities.

The proposed arrangement also solves the problem of introducing an abstraction layer in an administrative domain different from the domain where the applications are located, while also addressing applications developed by means of web service based technologies, possibly deployed in an administrative domain different form the domain that implements the Parlay X web services.

Specifically, the presently preferred embodiment of the arrangement described herein addresses the following requirements:
web services such as Parlay X web services are deployed in the domain of the telecommunication operator and can be accessed by applications deployed in third party administrative domains: the interaction between the application and the web services is performed through a WS-Security protocol;
the behaviour of the web services can be configured, application by application, through subscription parameters: they can be used for personalizing the behaviour, for defining conditions for use and configuring data, e.g. those data concerning the off-line provisioning of notification handling;
the implementation of web services is performed by exploiting the components of a Parlay gateway already deployed in the operator infrastructure, namely: authentication, authorization and access control (e.g. use condition enforcement) is implemented by interacting with the framework functions; moreover, the configuration of the subscription parameters of an application to a web service can be performed through the administrative tools and interfaces of the Parlay framework;
the applications can access web services, in particular Parlay X Web Services, as “normal” web services, without specific operations related to the Parlay context.

### BRIEF DESCRIPTION OF THE ANNEXED DRAWINGS

The invention will now be described, by way of example only, by referring to the enclosed figures of drawing, wherein:

FIGS. 1 and 2, related to the prior art, were already described in the foregoing;

FIG. 3 is a functional block diagram showing the context of the arrangement described herein;

FIG. 4 is a functional block diagram showing the initialization phase and method invocation within the arrangement described herein;

FIG. 5 is another functional block diagram showing the handling of notifications within the arrangement described herein;

FIG. 6 is still another functional block diagram showing the interactions for session control within the arrangement described herein; and

FIG. 7 is a flow chart illustrative of certain processes taking place within the framework of the arrangement described herein.

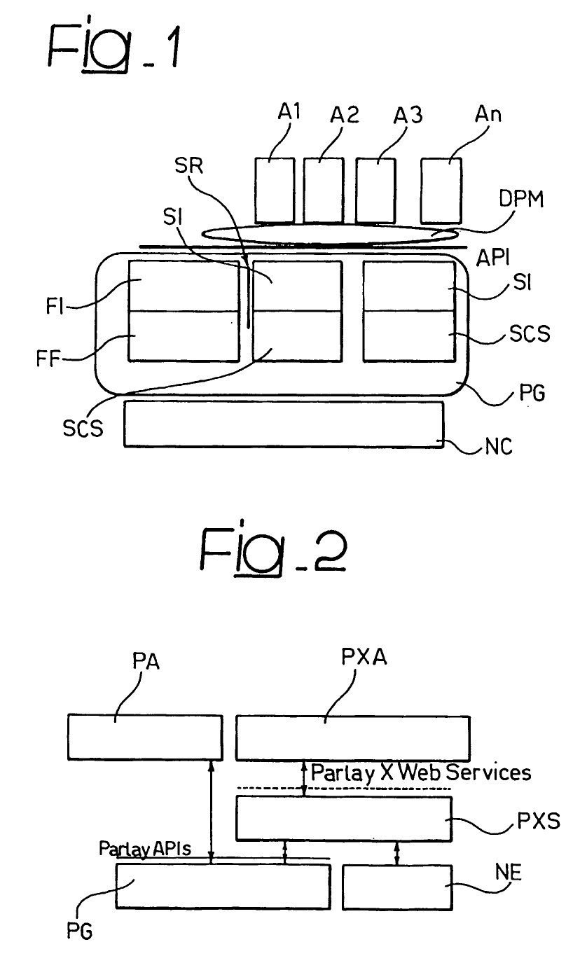

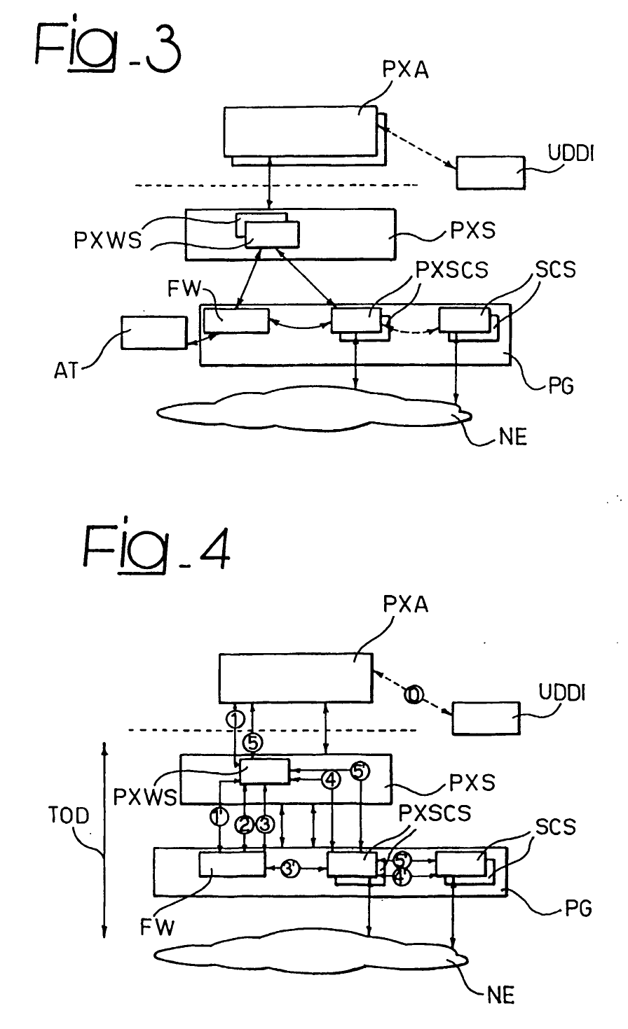

### DETAILED DESCRIPTION OF PREFERRED EMBODIMENTS OF THE INVENTION

By way of introduction, the basic components of the arrangement described herein (FIGS. 3 and 4 to 6) will be presented by referring to a context including certain features/elements that were already described in the foregoing.

Once again it will be appreciated that even though the rest of the detailed description herein will be made by referring primarily to access to Parlay X web services, the arrangement described herein can also be applied in providing secure and controlled access to—any—generic web services, and not only to Parlay X web services.

Parlay X Applications (PXAs): these are software applications that interact with Parlay X web services in order to accomplish their purposes;

UDDI: this is a UDDI (Universal Description, Discovery and Integration—or Interface) server that could be optionally used by Parlay X applications to retrieve the references to the Parlay X web services, according to the web service model;

Parlay X Server (PXS): it is a server (or multiple servers) that hosts and executes the implementations of PX WSs;

PX WSs: these are software modules that provide to the Parlay X applications PXAs Parlay X web services interfaces and behave as proxy in order to perform authentication, authorization, execution requests on the Parlay gateway functions/modules on behalf of the Parlay X applications;

Parlay gateway (PG): it is a system, possibly distributed on multiple servers, that implements the functions to provide Parlay APIS; it consists of:
a framework (FW), i.e. a module that implements the Parlay framework functions and APIs, including authentication, authorization, service discovery and selection, service subscription profile management, service registration service life-cycle;
SCS: these are modules that implement service interfaces, either standardized by Parlay or proprietary; and
PX SCS: these are software modules that implement the behaviour of the Parlay X web services, possibly allowing the customization according to the data (i.e. service properties) contained in the service subscription profiles handled by the framework.

Administrative tools (AT): these are software applications for the configuration of the data related to the Parlay gateway (e.g. handling of application subscription, configuration, etc.);

Network elements (NE): these are the network resources that implement the network capabilities (e.g. location server, switches, SIP servers, SMS centers).

The typical interfaces/protocols used for the interactions meet the following requirements:
the Parlay X applications (optionally) interact with the UDDI server through UDDI protocol;
the Parlay X applications interact with the Web Services offered by PX WSs by using WS-Security protocol (or alternative protocols adapted to ensure secure access to web services);
PX WSs interact with the framework FW through the Parlay framework APIs over a distributed processing mechanism, e.g. CORBA;
PX WSs interact with PX SCSs through an API invoked over a distributed processing mechanism, e.g. CORBA;
PX SCSs interact with the framework FW through the Parlay Framework APIs over a distributed processing mechanism, e.g. CORBA;
PX SCSs interact with the Parlay SCSs through the Parlay APIs over a distributed processing mechanism, e.g. CORBA.

A preferred implementation of a Parlay X web service consists of two parts, named respectively PX WS and PX SCS:
the PX WS part is a web service which implements the Parlay X web service APIs, plus some generic methods for session management; it behaves as a proxy on behalf of the application in order to perform the operations of authentication, access control on the framework and notification handling, as well as method invocation on the corresponding PX SCS;
the PX SCS part implements the behaviour of the Parlay X web service; it is an SCS for the Parlay framework and interacts with it (the framework) through the standard Parlay APIs (e.g. Service Registration and Service Life-Cycle); in particular, the PX SCS part has to perform a registration phase to the framework as any other SCSs; it could either use other SCSs in order to access the resources or directly access them by using the interfaces provided by the resources; its behaviour can be configured according to the service properties subscribed by the application, for personalization purposes or verifying constraints/conditions (e.g. use conditions according to the service level agreement or SLA) on the use of the Parlay X Web Service.

The interface between the two parts is structured in the following way:
the interface offered by the PX SCS part to the PX WS part consists of the same methods (transformed in IDL with additional parameters to deal with the explicit transmission of security data) provided by the Parlay X Web service to the application;
the interface offered by the PX WS part to the PX SCS part consists of the methods to be invoked when the PX WS part has to provide some notification (if the Parlay X web service is not required to handle notification, this interface is not needed).

From the point of view of the development of a Parlay X Web Service implementation, the Parlay X web service, including the control of use condition are implemented in the PX SCS part; the PX WS part is, on the other hand, almost similar for all the Parlay X web services, and could be derived from a common software template.

A basic advantage of the arrangement described herein lies in the interworking of the security mechanisms in the Parlay framework and in the WS-Security protocol, which are based on “dual”/opposite principles, as better detailed in the following.

An application that has to use the Parlay X web service will subscribe it and provide the configuration data (e.g. for representing personalization requirements or the use conditions included in the service level agreement, or SLA). It results in the subscription of the corresponding PX SCS and in the configuration of its service properties: both operations are performed by using the interfaces/administrative tools provided by the framework FW. The service properties include a copy of the application password, which is the secret key shared between the Parlay gateway and the application used to authenticate the application, and the off-line provisioned data concerning the handling of notifications.

In addition to the methods included in the Parlay X web service, a PX WS provides the following methods for session handling (the names provided herein have purely exemplary nature):
start-session (appl-id,call-backURL): this method is the first method invoked by the application appl-id, in order to start to use the Parlay X web service; call-backURL is the reference of the web service provided by the application and invoked by the Parlay web service in order to verify if the application is still active;
close-session: this method should be invoked by an application in order to terminate a session of use of the Parlay X web service; an application, which terminates without invoking this methods, is detected by the Parlay X web service as it has to periodically invoke the call-back method still-alive (see below) provided by the application;
challenging-PXWS (challenging-token)->hashed-token: this (optional) method could be used by the application in order to periodically check the identity and the active status of the Parlay X web service. The identity of the Parlay X web service is verified though a challenge mechanism: the Parlay X web service has to return as a result the challenging-token hashed with the application password (i.e. the shared secret key between the application and the Parlay infrastructure).

Moreover, any application wishing to use a Parlay X web service implements a web service with the following method:

still-alive (challenging-token)->hashed-token: this method is invoked by the PX WS part of the Parlay X web service in order to check that the application is still active and to verify its identity, through a challenge mechanism; the application has to return as a result the challenging-token hashed with the application password (i.e. a shared secret key between the application and the Parlay infrastructure).

A Parlay X application that is invoking a method of a Parlay X web service includes authentication data in each of its invocations (e.g. by using some WS-security mechanisms), including the application identifier, the password in a digest format, and some additional information (selected and/or generated by the application, e.g. a timestamp and a message identifier) used by the application to hash the password (e.g. the digest format of the password could be the result of a hash algorithm that takes as a input the password, the additional information). In order to verify the identity of the client application, the implementation of the Parlay X web service executes the same hash algorithm, by using as input the stored password associated to the application identifier and the received additional information. The authentication succeeds if the result is equal to the received digest password. The same method and information are used by the Parlay X web service implementations in order to provide the authentication data in invocations performed to notify events to applications.

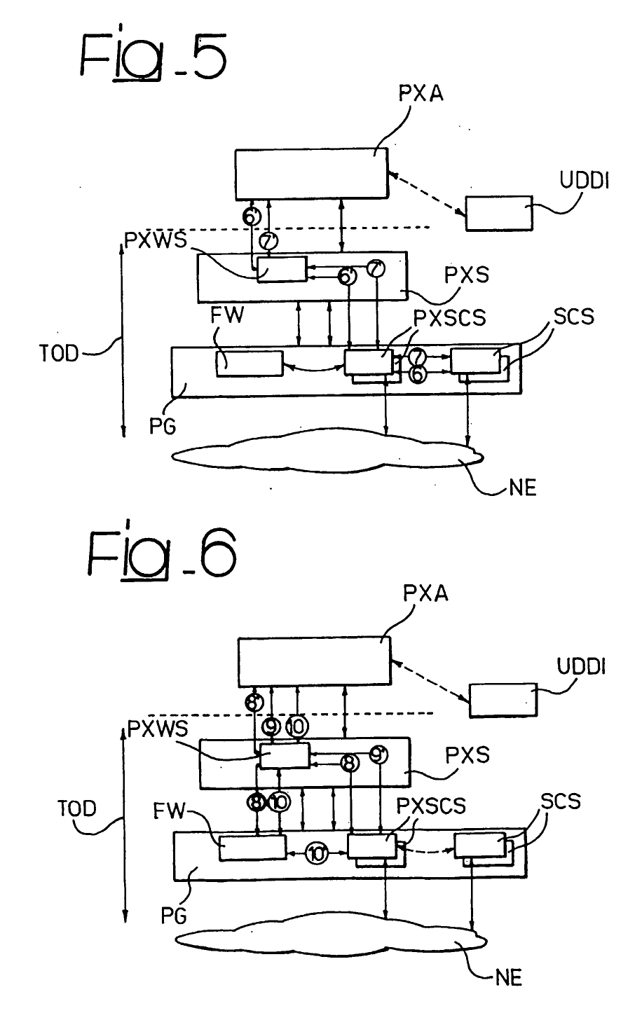

The interactions among the components are better described in FIGS. 4 to 6 where the same references already described in connection with FIG. 3 apply and the telecommunication operator domain (TOD) has been specifically highlighted: each interaction will be detailed in the following subsections.

FIG. 4 shows the interactions for the start of a use session of a Parlay X web service and the invocation of its methods:

0—the application accesses the UDDI server in order to get the WSDL related to the needed Parlay X web service; the WSDL includes the binding information on how to access the Parlay X web service provided by PX WS part of its implementation; this step could be optional in the case the application had the possibility to receive the WSDL in an alternative way (e.g. a direct communication);

1—the application requires to initialise a use session on the Parlay X web service, by invoking (by means of SOAP protocol) the start-session method; the PX WS part interacts with the Parlay framework (1′), by performing the authentication phase on behalf of the application (details of the authentication procedure are provided below);

2—the PX WS performs on behalf of the application the selection of the PX SCS; the Parlay framework verifies whether the application is authorized to use PX SCS: this check corresponds to verify is the application is authorised to use the Parlay X web service requested;

3—the PX WS performs on behalf of the application the “sign service agreement” procedure: a new instance of the PX SCS interface is created instantiated according to the service properties in the subscription profile of the application (3′);

4—the PX WS performs an internal configuration phase; in the case of a Parlay X Web Service with notifications during this step the new instance of the PX SCS requires to enable the notifications subscribed by the application (4′); the PX WS stores all the information concerning the access session requested by the application in a context;

5—the application performs (by means of WS-Security protocol) the request of a method of the Parlay X web service to the PX WS, which forwards the request to the interface instance of PX SCS associated to the application (5′); such instance checks the identity of the application, verifies whether the use conditions are fulfilled, and, then, processes the request, by possibly invoking the SCS to access the resources (5″); if the application has not yet performed in a successful way the initialisation phase, the PX WS returns an exception. This step could be repeated several times, one for each invocation performed by the application.

FIG. 5 shows the handling of notifications to inform Parlay X applications of events produced by network resources.

Two cases are possible, namely:
the case described in point 6, which is just the communication of an event that is internally processed by the application, and
the case described in point 7, which requires the application to return to the Parlay X web service the results of processing of the event.

Specifically:

6—an event notification is received by the PX SCS from a resource, possibly mediated by a SCS; the PX SCS forwards the notification to the PX WS, by including the binding information (provided in the off-line provisioning phase) of the web service to be invoked, as a call-back, on the application (6′) the Parlay X web service notifies the application by invoking the call-back web service (by means of WS-Security protocol—6″);

7—an event to be handled by an application is notified to the PX SCS by a resource, possibly mediated by a SCS; the PX SCS forwards the notification to the PX WS, by including the binding information (provided in the off-line provisioning phase) of the Web Service to be invoked, as a call-back, on the application (7′); the PX WS notifies the application by invoking the call-back Web Service (by means of WS-Security protocol); the application processes the notified event and returns to PX WS in the response the commands that are performed by the network; PX WS returns the response data to PX SCS, which processes them.

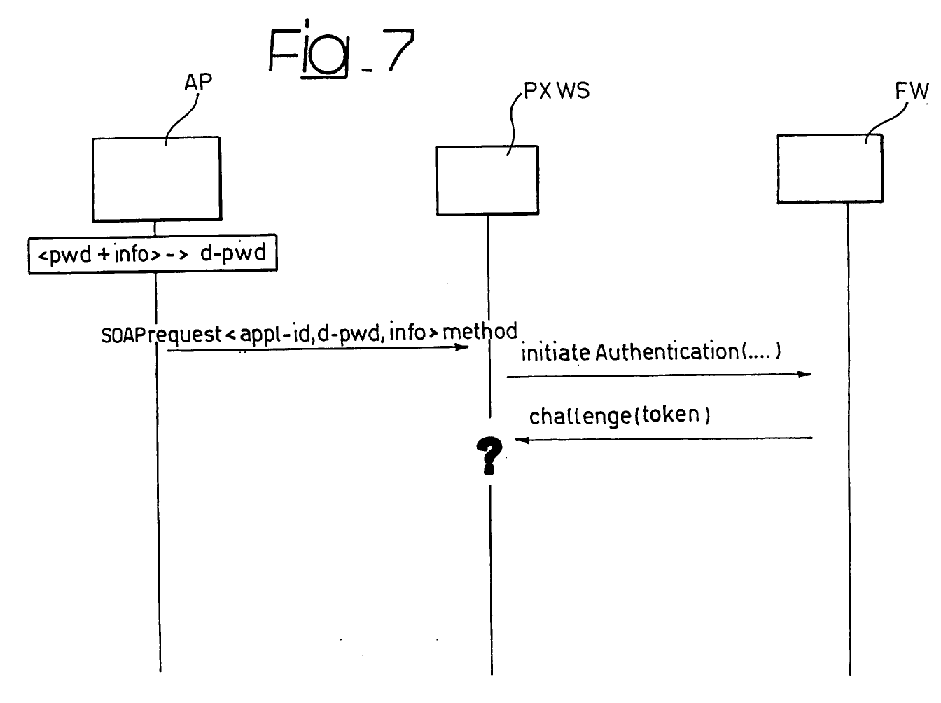

FIG. 6 describes the interactions related to the control on the session:

8—during the period an application is using a Parlay X web service the Parlay framework could challenge the application; the challenge request is sent to the PX WS, which forwards them to the application, by invoking the “still-alive” method (8′); the application returns the result of the hashing of the challenging token with its password; in case the challenge fails (because either the application is not longer alive or returns a wrong answer to the challenge), the framework aborts the access session of the application, and terminates the PX SCS instance associated to them, and, moreover the PX WS removes the context with the information related to the application; invocation (8″) could be performed by the PX WS autonomously just to verify if the application is still alive;

9—during the period an application is using a Parlay X web service the application could challenge the Parlay X web service; the challenge request is sent by invoking (by using WS-Security protocol) the generic method challenging-PXWS; the request is forwarded by the PX WS to the corresponding PX SCS instance, which returns the result of hashing the received challenging token with the copy of the application password (included in the service properties received when created); alternatively it could forward the challenge to the Parlay framework;

10—if an application wants to terminate a use session with a Parlay X web service, it invokes (by using WS-Security protocol) the generic method close-session; the PX WS invokes the Parlay framework in order to terminate the access session on behalf of the application (10′); the Parlay framework terminates the access session and informs the PX SCS to terminate the instance associated to the application (10″); the PX WS releases the context associated to the application; if the application needs to contact the Parlay X web service again it has to activate a new use session, by invoking the generic method start-session on the Parlay X Web Service.

The specific implementation of the step identified in the foregoing, and the related interactions performed in the system are based on standard Parlay interfaces. These are well known in the art and do not require to be described in detail herein.

The arrangement described herein permits a network operator that has already deployed a Parlay gateway to reuse it and the associated administrative systems in order to perform:
the authentication of software applications accessing Parlay X web services;
the authorization checks on the applications to access specific Parlay X web services;
the configuration of the profile containing the data characterizing the subscription of an application to a Parlay X web service;
the binding of an application to a specific Parlay X web services, customized according to the corresponding subscription profile data.

In the absence of such facilities a network operator would have to develop/deploy new systems to address and configure a secure and controlled access to Parlay X web services from external applications.

It will be appreciated that Parlay was originally defined outside the context of web services (i.e. the Parlay framework was not defined to play the role of an authentication server or an authorization server for web services), and that the application of Parlay framework to the web service context required to solve several technical issues.

In fact the Parlay framework and the web service technologies address similar functions in opposite ways. For instance:
according to the Parlay model, an application performs an authentication and authorization phase before performing (several) invocations on a service interface; on the other hand, in the web service model the execution of each invocation includes a verification of the authentication and the authorization of the application;
the authentication of an application in the Parlay model is based on a challenge approach; on the other hand, in the web services model the authentication servers are based on a request-response model (see below);
the authentication and the authorization solutions for Parlay X web services are able to deal with the notification of event produced by the network resources; such aspects are not to be considered in the Web Services case, as the web service model is based on a request-response interaction model, where the application performs the client/requestor role and the Web Service the server role.

Concerning specifically authentication, one of the problems solved by the arrangement disclosed herein relates to the procedure of authentication performed by the PX WS part on behalf of the requesting application.

Both the WS-Security “username-password” profile adopted in the detailed description and Parlay/OSA framework authentication processes are based on the fact that a “shared secret”, e.g. the password associated to the application, is shared among the application and the server in charge of performing the authentication. According to the described solution, the password should be shared between the application and the Parlay/OSA framework: in fact, the PX WS part is just in charge to behave as a proxy in the authentication steps.

A Parlay X application that is invoking a method of a Parlay X web service includes authentication data in each of its invocations (e.g. by using some WS-Security mechanisms), including the application identifier, the password in a digest format, and some additional information (selected and/or generated by the application, e.g. a timestamp and a message identifier) used by the application to hash the password (e.g. the digest format of the password could be the result of a hash algorithm that takes as an input the password, and the additional information for hashing the password). In order to verify the identity of the client application, the implementation of the Parlay X web service executes the same hash algorithm, by using as input the stored password associated to the application identifier and the received additional information. The authentication succeeds if the result is equal to the received digest password. The same method and information are used by the Parlay X web service implementations in order to provide the authentication data in invocations performed to notify events to applications.

According to the API level authentication in Parlay specification (this is the level usually supported by all the Parlay/OSA gateway products), when a Parlay application starts the authentication procedure, the framework sends a “challenge” to the Parlay application. It executes then hash algorithm, which was previously agreed among the application and the framework, by combining the password and the received challenge, and return the result. The framework has to perform the same operation on the password associated to the application and stored in the gateway. The authentication succeeds if the result is equal to the data returned by the application.

As shown in FIG. 7, in the arrangement described herein, the PX WS part per se is not able to handle the authentication steps, as it is not sharing the knowledge of the application password AP. Nor is it able to check the digest password d-pwd sent by the application and to answer the challenge request sent by the Parlay framework FW.

Additionally, the authentication procedure is repeated at each invocation on the Parlay X web service methods performed by the application: also in this case there is a conflict between the two authentication mechanisms. In fact WS-Security requires an authentication for each method invocation, while Parlay does not require it (as it assumes that only the authenticated and authorized applications can invoke a method on an SCS interface instance during a Parlay access session).

Moreover, the Parlay framework FW can send during the life-time of an access session some challenge to the application: the Parlay framework would send the challenge to the Parlay X web service implementation, which is not able to handle it directly.

The arrangement described herein addresses all these points in a fully satisfactory manner.

In fact, the arrangement described herein allows the Parlay framework functions to be reused fully. To that end, the Parlay X web service behaves as a proxy accessing the Parlay gateway on behalf of the Parlay X applications, and not as a simple Parlay application. Access a Parlay gateway according to a Proxy mode on behalf of an application is therefore a fully original approach.

By way of alternative, an optimised implementation could design the two parts PX WS and PX SCS as a single software module, so that such a CORBA interface could be an interface internal to the module.

Also, a Parlay X web service could be implemented directly on the network elements. In that case, the corresponding PX SCS would directly interwork with network elements through the network protocols (e.g. INAP, SIP, MAP, etc.), without the involvement of Parlay SCSs. Moreover, also the notification handling would not require the involvement of Parlay SCSs.

The arrangement described herein is still applicable if the Parlay X web services are invoked with a protocol for web service security alternative to the “username-password” profile of WS-Security.

For instance:
if HTTP digest authentication is used to transport SOAP, the information used to hash the password is proposed by the invoked entity;
if the SAML-based profile of WS-Security is used, the start-session method could return a SAML assertion generated by the PX-WS component of the Parlay X implementation; such assertion could be included in the following method invocation of that Parlay X Web Service to prove that the application is authenticated and authorised to use the Web Service.

As an alternative to using a password as a shared secret to authenticate applications, the authentication could be based on (public and private) keys: the application uses its private key to hash the information, while the Web Service implementation uses the public key to verify the hashed information.

The contents of the WS-Security requests and responses could be encrypted, by using either the shared password or the keys.

Significantly, the arrangement described herein can also be applied to introduce a secure and controlled access to—any—generic web services, and not only to Parlay X web services. Therefore the invention can be used to exploit the framework component of a Parlay gateway as servers for authentication and authorization to access web services.

In fact, any generic web service can be implemented by means of the arrangement described herein, by splitting it in a WS part and in an SCS part. Moreover, such modules would be integrated and configured in the Parlay gateway as any other Parlay X web services.

It is thus evident that, the basic principles of the invention remaining the same, the details and embodiments may widely vary with respect to what has been described and illustrated purely by way of example, without departing from the scope of the presented invention as defined in the annexed claims.

1-22. (canceled)

23. A method for providing to software applications access to web services, comprising the steps of:
providing a Parlay gateway permitting access to web services, said Parlay gateway comprising a Parlay framework; and
providing a set of modules comprising service interfaces for said software applications, the modules in said set acting as proxies in order to perform requests for access to web services on the framework of said Parlay gateway on behalf of said software applications.

24. The method of claim 23, comprising the step of configuring the modules in said set for performing authentication, authorization, and execution requests on said Parlay gateway on behalf of said software applications.

25. The method of claim 23, comprising the step of providing a further set of modules configured for implementing the behaviour of said web services once said requests on said Parlay framework of said Parlay gateway have been performed on behalf of said software applications by the modules in said set.

26. The method of claim 23, wherein said web services are Parlay X web services.

27. The method of claim 23, comprising the step of defining at least one web service security protocol for ensuring secure interaction between said software applications and the modules in said set.

28. The method of claim 23, comprising the step of providing a distributed processing mechanism enabling said modules in said set to interact with said Parlay framework in said Parlay gateway via said distributed processing mechanism.

29. The method of claim 28, wherein said distributed processing mechanism is CORBA.

30. The method of claim 25, comprising the step of providing a respective distributed processing mechanism enabling said modules in said further set to interact with said Parlay framework in said Parlay gateway via said respective distributed processing mechanism.

31. The method of claim 30, wherein said respective distributed processing mechanism is CORBA.

32. The method of claim 25, wherein the step of one of said software applications accessing a web service comprising the steps of:
said software application subscribing a module in said further set corresponding to said web service; and
configuring the service properties of said subscribed module in said further set, wherein both said operations are performed by using the tools provided by said Parlay framework in said Parlay gateway.

33. A system for providing to software applications access to web services, comprising:
a Parlay gateway permitting access to web services, said Parlay gateway comprising a Parlay framework; and
a set of modules comprising service interfaces for said software applications, the modules in said set being configured for acting as proxies in order to perform requests for access to web services on the framework of said Parlay gateway on behalf of said software applications.

34. The system of claim 33, wherein the modules in said set are configured for performing authentication, authorization, and execution requests on said Parlay gateway on behalf of said software applications.

35. The system of claim 33, comprising a further set of modules configured for implementing the behaviour of said web services once said requests on said Parlay framework of said Parlay gateway have been performed on behalf of said software applications by the modules in said set.

36. The system of claim 33, wherein said web services are Parlay X web services.

37. The system of claim 33, comprising at least one web service security protocol for ensuring secure interaction between said software applications and the modules in said set.

38. The system of claim 33, comprising a distributed processing mechanism enabling said modules in said set to interact with said Parlay framework in said Parlay gateway via said distributed processing mechanism.

39. The system of claim 38, wherein said distributed processing mechanism is CORBA.

40. The system of claim 35, comprising a respective distributed processing mechanism enabling said modules in said further set to interact with said Parlay framework in said Parlay gateway via said respective distributed processing mechanism.

41. The system of claim 40, wherein said respective distributed processing mechanism is CORBA.

42. The system of claim 35, wherein the modules in said further set are configured for permitting said software applications to access a web by the steps of:
said software application subscribing a module in said further set corresponding to said web service; and
the service properties of said subscribed module being configured in said further set, wherein both said operations are performed by using the tools provided by said Parlay framework in said Parlay gateway.

43. A communication network comprising the system of claim 33.

44. A computer program product loadable in the memory of at least one computer and comprising software portions capable of performing the method of any of one of claims 23 to 32.
